(19) United States
(12) Patent Application Publication
(10) Pub. No.: US 2026/0280901 A1
(43) Pub. Date: Sep. 17, 2026

(54) SECURE TERMINAL ROOT OF TRUST DELEGATION TO EXTERNAL PERIPHERAL HUB

(71) Applicant: Microsoft Technology Licensing, LLC, Redmond, WA (US)

(72) Inventors: Yoel Yehezkel EINHOREN, Petah Tiqwa (IL); Assaf BAR - NESS, Rehovot (IL); Shoham DEKEL, Tel Aviv (IL)

(21) Appl. No.: 19/078,620

(22) Filed: Mar. 13, 2025

(51) Int. Cl. H04L 9/32

(52) U.S. Cl. CPC H04L 9/3263

(57) ABSTRACT

The techniques described herein involve methods, systems, and computer program products for secure communication between a hub security controller of a peripheral hub and a system security controller of a computer system. The hub security controller identifies a request to enter a secure peripheral mode, establishes a communication channel with the system security controller by presenting a cryptographic certificate, and sends a credential based on user interaction with a peripheral device. Upon receiving acknowledgment, the hub security controller requests and receives a second cryptographic certificate, replacing the first for future sessions. The system security controller receives the credential, compares it with a second credential from another peripheral device, and sends acknowledgment if they match. It then generates and sends the second cryptographic certificate to the hub security controller. This process ensures secure communication and credential verification between the hub and system security controllers.

### BACKGROUND

In today's digital landscape, ensuring secure communication and data integrity between peripheral devices and computer systems is paramount. In many organizations, employees access sensitive resources in the cloud, leading to the use of secure workstations. These secure workstations, known as Secure Admin Workstations (SAWs), are equipped with hardened, minimal operating systems (OSs) and are factory-assigned to specific users. These workstations enabled users to remotely access sensitive cloud resources while ensuring that secure data is protected. For instance, if the sensitive cloud resource is a virtual machine (VM), SAWs ensure that inputs to the VM and outputs from the VM are secured.

The evolution of SAWs has led to the development of secured access VMs running on user workstations—essentially an SAW in the form of a VM. These secured access VMs enable access to sensitive cloud resources even from non-hardened workstations considered insecure compared to an SAW. These secured access VMs utilize confidential VM technology, e.g., utilizing encrypted VM memory that is inaccessible to the workstation's OS, to protect access to sensitive cloud resources. Additionally, secured access VMs ensure secure input and output handling. In some examples, secured access VMs cooperate with trusted embedded controllers (ECs) in workstations, with the ECs encrypting inputs directed to and outputs from the VM, thereby preventing the local OS from accessing sensitive cloud information being interacted with through the VM.

The subject matter claimed herein is not limited to embodiments that solve any disadvantages or that operate only in environments such as those described supra. Instead, this background is only provided to illustrate one example technology area where some embodiments described herein may be practiced.

### SUMMARY

In some aspects, the techniques described herein relate to methods, systems, and computer program products, implemented as a hub security controller of a peripheral hub, including: identifying a first request to enter a secure peripheral mode; establishing a communication channel with a system security controller in a computer system that is communicatively coupled to the peripheral hub, wherein establishing the communication channel includes presenting a first cryptographic certificate to the system security controller; sending a credential via the communication channel to the system security controller, the credential being identified based on user interaction with a peripheral device coupled to the peripheral hub; receiving an acknowledgment of acceptance of the credential by the system security controller via the communication channel; sending a second request for a second cryptographic certificate via the communication channel to the system security controller; receiving the second cryptographic certificate from the system security controller via the communication channel; and binding the hub security controller to the system security controller, including replacing the first cryptographic certificate with the second cryptographic certificate for establishing a subsequent communications session with the system security controller.

In some aspects, the techniques described herein relate to methods, systems, and computer program products, implemented as a system security controller of a computer system, including: establishing a communication channel with a hub security controller in a peripheral hub that is communicatively coupled to the computer system; receiving a first credential via the communication channel from the hub security controller, the first credential originating from a first peripheral device coupled to the peripheral hub; receiving a second credential from a second peripheral device coupled to the system security controller; determining that the first credential and the second credential are identical; sending an acknowledgment via the communication channel of acceptance of the first credential to the hub security controller; receiving a request for a cryptographic certificate via the communication channel from the hub security controller; generating the cryptographic certificate; and sending the cryptographic certificate via the communication channel to the hub security controller.

In some aspects, the techniques described herein relate to methods, systems, and computer program products, a hub security controller of a peripheral hub; and a system security controller of a computer system communicatively coupled to the peripheral hub, and wherein the hub security controller: identifies a first request to enter a secure peripheral mode; establishes a communication channel with the system security controller based on identifying the first request, wherein establishing the communication channel includes presenting a first cryptographic certificate to the system security controller; sends a first credential to the system security controller via the communication channel, the first credential being identified based on user interaction with a peripheral device coupled to the peripheral hub; receives an acknowledgment of acceptance of the first credential by the system security controller via the communication channel; sends a second request for a second cryptographic certificate via the communication channel to the system security controller; receives the second cryptographic certificate from the system security controller via the communication channel; and binds the hub security controller to the system security controller, including replacing the first cryptographic certificate with the second cryptographic certificate for establishing a subsequent communications session with the system security controller, and the system security controller: receives the first credential via the communication channel; receives a second credential from a second peripheral device coupled to the system security controller; determines whether the first credential and the second credential are identical; sends the acknowledgment via the communication channel when the first credential and the second credential are identical; receives the second request for the second cryptographic certificate via the communication channel from the hub security controller; generates the second cryptographic certificate; and sends the second cryptographic certificate via the communication channel to the hub security controller.

This Summary introduces a selection of concepts in a simplified form that are further described below in the Detailed Description. This Summary is not intended to identify key features or essential features of the claimed subject matter, nor is it intended to be used to determine the scope of the claimed subject matter.

### BRIEF DESCRIPTION OF THE DRAWINGS

To describe how the advantages of the systems and methods described herein can be obtained, a more particular description of the embodiments briefly described supra is rendered by reference to specific embodiments thereof, which are illustrated in the appended drawings. These drawings depict only typical embodiments of the systems and methods described herein and are not, therefore, to be considered to be limiting in their scope. Systems and methods are described and explained with additional specificity and detail through the use of the accompanying drawings, in which:

FIG. 1 illustrates an example of a computer architecture for pairing a peripheral hub with a system security controller of a computer system;

FIG. 2 illustrates an example communication diagram for pairing a hub security controller of a peripheral hub with a system security controller of a computer system;

FIG. 3 illustrates an example of a system security controller issuing a security certificate to a hub security controller; and

FIG. 4 illustrates a flow chart of an example of a method for pairing a hub security controller of a peripheral hub with a system security controller of a computer system.

### DETAILED DESCRIPTION

While secured access virtual machines (VMs) have improved the administrative ease of providing Secure Admin Workstation (SAW)-type functionality and have reduced cost, there are still challenges with providing flexible end-user experiences. For example, an embedded controller (EC) within a workstation that supports secured access VMs is generally configured—for security reasons—to accept inputs only from pre-configured input devices, such as an integrated keyboard and trackpad within a laptop computer. For instance, a workstation with an EC can be constructed in a way to ensure that inputs received at these pre-configured input devices can be securely routed to the secure access VM without being intercepted by an operating system (OS) or software executing therein. In one example, a communication channel to which these pre-configured input devices are connected may pass through the EC, ensuring that the EC can encrypt inputs before they may potentially become visible to the OS. Due to these security designs, secure access VMs cannot operate with additional peripheral devices, such as external keyboards and mice. This presents a degraded user experience because users must exclusively use the pre-configured input devices when using a secured access VM. This can be a significant inconvenience in many common configurations, such as when a laptop's lid is closed, e.g., when the laptop is being used with a docking station.

The present disclosure addresses these challenges with methods, systems, and computer program products that facilitate pairing a peripheral hub and a system security controller (e.g., an EC) of a computer system. The peripheral hub enables connections to peripheral input devices, such as external keyboards and mice. The pairing of the peripheral hub and the system security controller ensures that inputs received from peripheral input devices connected to the peripheral hub can be securely routed to a secure access VM without being intercepted by an OS or applications executing therein. By allowing the use of external peripheral devices, such as keyboards and mice, with secured access VMs, the peripheral hub described herein significantly improves the user experience and usability of secured access VMs while maintaining the high-security standards of secured access VMs. Additionally, the peripheral hub described herein allows generic external peripheral devices to be used with secured access VMs. In other words, the peripheral hub described herein enables external peripheral devices that lack cryptographic capability (e.g., to be part of a cryptographic trust chain) to be used with secured access VMs.

In some embodiments, a pairing process includes the system security controller receiving and verifying a specific secret (e.g., a pin) at one of the pre-configured input devices (e.g., a built-in keyboard) and an input device connected to the peripheral hub. This pin is used by the system security controller to make sure only a specific peripheral hub is allowed to be bound to the system. Notably, in embodiments, a peripheral hub can only be paired with a single system security controller at a time but can be re-paired to another system security controller. Thus, if a user connects the peripheral hub to a different workstation, they can re-pair the peripheral hub to that workstation—removing the pairing with the prior workstation. Additionally, if a user has multiple peripheral hubs, e.g., at different locations (e.g., home office, work office), they can re-pair each hub when they first connect to it after connecting to a different hub. Embodiments may further utilize cryptographic information received from a peripheral hub, such as a device identity certificate provisioned on the peripheral hub, a cryptographic device measurement, and the like, as part of a determination as to whether pairing with the peripheral hub is permitted. These embodiments, therefore, can utilize cryptographic identities to pair only with trusted peripheral hubs (e.g., to prevent pairing with unknown and/or potentially malicious peripheral hubs).

In embodiments, once a peripheral hub is paired with a system security controller, a secure access VM trusts the peripheral hub by virtue of the VM's trust relationship with the system security controller. Because the secure access VM now recognizes and trusts the peripheral hub, the peripheral hub can connect directly to the VM without an intermediary. For instance, the system security controller can be left uninvolved in the connection between a paired peripheral hub and the secured access VM. This improves input latency and reduces power consumption (e.g., by the system security controller).

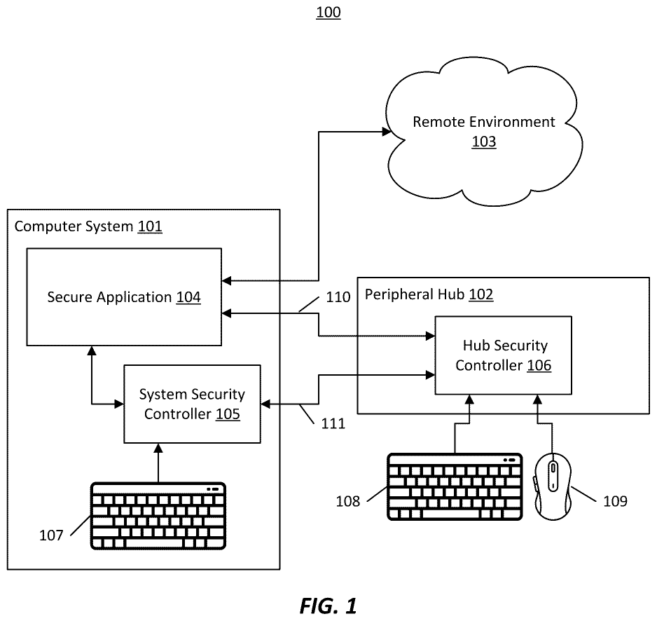

FIG. 1 illustrates an example 100 of a computer architecture for pairing a peripheral hub with a system security controller of a computer system. Example 100 includes a computer system 101, a peripheral hub 102, and a remote environment 103. Computer system 101 operates a secure application 104 that interacts with a remote environment. In some embodiments, the secure application 104 is a secured access VM that accesses sensitive resources in remote environment 103, such as sensitive code, sensitive business documents, sensitive government documents, and the like. In some examples, secure application 104 is a hardware—or software-based confidential VM, which isolates VM memory from an OS and applications executing at computer system 101. However, the secure application 104 could be any form of application for which measures are taken to isolate the secure application 104 from an OS and applications executing at computer system 101. Additionally, while secure application 104 accesses remote environment 103 in example 100, other examples of secure application 104 may operate locally at computer system 101 without access to remote environment 103.

Computer system 101 includes a system security controller 105. In some examples, system security controller 105 is an EC, such as a system-on-a-chip or a system-on-a package. In embodiments, system security controller 105 is a self-contained computer system, including, e.g., a processor system, a memory, and a storage medium (e.g., flash memory storing firmware). In general, the system security controller 105 provides hardware-based security isolation within the computer system 101. For example, system security controller 105 provides isolation for inputs received at a pre-configured input device, such as an integrated keyboard 107, enabling those inputs to be encrypted and routed directly to secure application 104 without those inputs being intercepted by an OS or applications executing at computer system 101.

In embodiments, the system security controller 105 is configured to be cryptographically trusted by secure application 104. For instance, the system security controller 105 may include a capability to prove its security state, based on, e.g., trust rooted in a trusted platform module (TPM) at computer system 101, one or more cryptographic identities embedded into system security controller 105 (e.g., during its manufacture), and/or measurements of its firmware and/or operating state. In some examples, the secure application 104 utilizes a separate attestation service (not shown), together with measurements obtained by system security controller 105, to determine if the current operational state of system security controller 105 is trusted. In embodiments, a trust relationship between secure application 104 and system security controller 105 is based on the possession of one or more cryptographic certificates by system security controller 105 that were issued by a certificate authority (CA) that is trusted by secure application 104.

In some examples, the certificates and related technologies described herein are based on the X.509 standard for public key certificates, which are widely used in cryptographic security systems such as Transport Layer Security (TLS) and digital signatures. The X.509 standard defines the format of digital certificates, which are used for authentication, encryption, and digital identity verification. As examples, an X.509 certificate may contain, among other things, one or more of a version (e.g., the X.509 standard version), a serial number (e.g., a unique identifier assigned by a CA), a signature algorithm (e.g., the cryptographic algorithm used to sign the certificate), and issuer (e.g., CA that issued the certificate), a validity period (e.g., the start and expiration date of the certificate), a subject (e.g., entity the certificate is issued to), a public key (e.g., the cryptographic public key associated with the certificate), and a signature (e.g., a cryptographic signature from the CA, verifying the certificate's authenticity).

In example 100, computer system 101 is interconnected (e.g., by an externally-facing bus, such as USB) to peripheral hub 102. Among other things, peripheral hub 102 includes a hub security controller 106 and accepts connections (e.g., via USB) to one or more peripheral input devices, such as the depicted keyboard 108 and mouse 109. Although peripheral hub 102 is depicted as being separate from keyboard 108 and mouse 109, in some examples, peripheral hub 102 is integrated into a peripheral device, such as a keyboard. In these examples, the keyboard would serve as a peripheral hub—and potentially enable additional peripheral devices to be connected thereto.

Similar to system security controller 105, in embodiments, hub security controller 106 is an EC, such as a system-on-a-chip or a system-on-a package. In embodiments, hub security controller 106 is a self-contained computer system, including, e.g., a processor system, a memory, and a storage medium (e.g., flash memory storing firmware). In example 100, communication channel 110 indicates that the hub security controller 106 can communicate with system security controller 105. Similarly, a communication channel 111 indicates that, in at least some embodiments, the hub security controller 106 can communicate with secure application 104 directly (e.g., bypassing system security controller 105). However, in other embodiments, the hub security controller 106 may communicate with secure application 104 indirectly (e.g., via system security controller 105).

In embodiments, the peripheral hub 102 pairs to system security controller 105, ensuring that inputs received from peripheral input devices (e.g., keyboard 108, mouse 109) connected to the peripheral hub 102 can be securely routed to secure application 104 without being intercepted by an OS or applications at computer system 101. In embodiments, this pairing process involves establishing a hardware root of trust between system security controller 105 and hub security controller 106. In embodiments, establishing a hardware root of trust between system security controller 105 and hub security controller 106 includes creating a cryptographic certificate chain that is tied to both the hardware and the firmware of the hub security controller 106. The certificate chain allows the hub security controller 106 to securely attest to its authenticity and integrity.

In one example, a hardware root of trust is established using Device Identifier Composition Engine (DICE) techniques, though various techniques could be used. Using DICE, the system security controller 105 and the hub security controller 106 are each provisioned with a device identity certificate. For example, the system security controller 105 and hub security controller 106 may be provisioned with corresponding device identity certificates during manufacturing and/or later by an organization (e.g., after a device has undergone additional validation, such as hardware inspection or the addition of physical tamper detection mechanisms). In embodiments, these device identity certificates are signed by the same CA, which allows the system security controller 105 and the hub security controller 106 to use their respective device identity certificates to establish a secure communication channel between them, e.g., using TLS.

In embodiments, a pairing process includes the system security controller 105 and the hub security controller 106 establishing a secure communications channel (e.g., communication channel 111) with each other, the system security controller 105 validating a credential (e.g., a PIN) received from the hub security controller 106 over the secure communications channel, the hub security controller 106 sending a Certificate Signing Request (CSR) to the system security controller 105 over the secure communications channel, and the system security controller 105 signing the CSR and sending a signed certificate to the hub security controller 106.

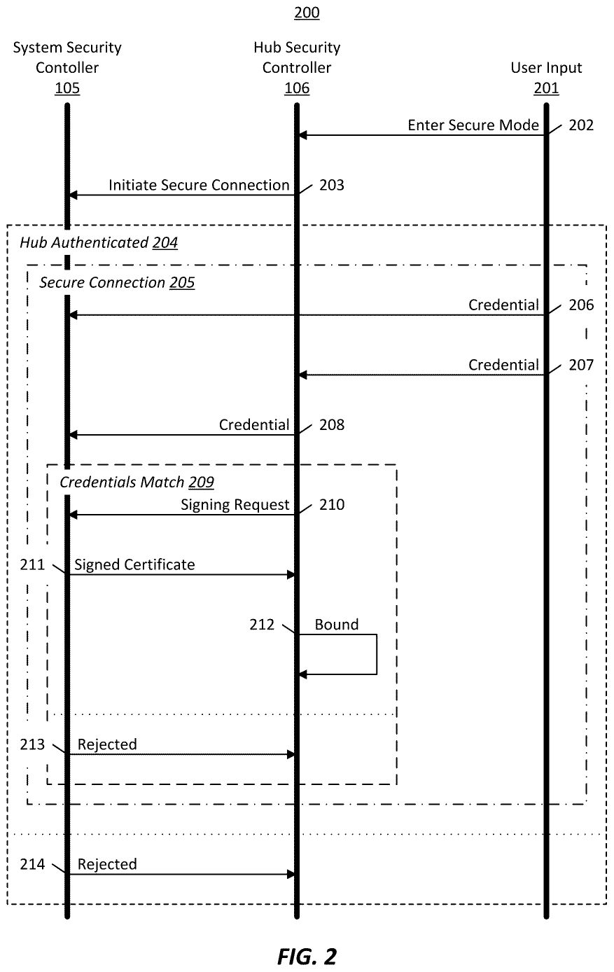

To describe this pairing process in additional detail, FIG. 2 illustrates an example communication diagram 200 for pairing a hub security controller of a peripheral hub with a system security controller of a computer system. Communication diagram 200 includes a column for hub security controller 106, a column for hub security controller 106, and a column representing user-entered inputs 201 (e.g., inputs entered at keyboard 107 and/or at keyboard 108).

Beginning at time 202, a user input is received at hub security controller 106 for entering a secure mode of the peripheral hub. For example, the user input could be a key press or key combination at keyboard 108 or the pressing of a pairing button on peripheral hub 102. In some embodiments, to enter the secure mode, user inputs are needed concurrently at computer system 101 and peripheral hub 102. For example, a user initiates the secure mode by concurrently pressing the same key or key combination on keyboard 107 and keyboard 108.

Based on the user input at time 202, at time 203, the hub security controller 106 initiates a secure connection with the system security controller 105. The establishment of this secure connection is indicated by box 204, labeled “hub authenticated,” and box 205, labeled “secure connection.” In one example, the hub security controller 106 initiates a TLS connection with the system security controller 105, with that TLS connection being authenticated (box 204) and established (box 205) by device identity certificates provisioned onto the system security controller 105 and the hub security controller 106 (e.g., during manufacturing or later by an organization). As shown at time 214, if authentication fails, the system security controller 105 rejects the connection.

Once a secure connection is established between the system security controller 105 and the hub security controller 106, at time 206 and time 207, the user provides a credential to each of the system security controller 105 and the hub security controller 106. For example, the user enters the same PIN at keyboard 107 and keyboard 108. At time 208, the hub security controller 106 communicates the credential it received to the system security controller 105. Notably, the temporal order of the system security controller 105 receiving a user-entered credential can vary relative to the hub security controller 106 receiving a user-entered credential and/or relative to the hub security controller 106 communicating that credential to the system security controller 105. For example, time 206 may occur before both time 207 and time 208, after both time 207 and time 208, or between time 207 and time 208. The system security controller 105 verifies if the credentials match and potentially verifies if the pairing should be permitted (e.g., based on policy). If so (indicated by box 209, labeled “credentials match”), the system security controller 105 sends an acknowledgment (not shown) to the system security controller 105. As shown at time 213, if the credentials don't match or if the pairing is determined to be not permitted, the system security controller 105 rejects the connection.

At time 210, after receiving the acknowledgment, the hub security controller 106 sends a signing request, e.g., an X.509 CSR, to the system security controller 105. In the example of DICE, the hub security controller 106 derives a Compound Device Identity (CDI) using a cryptographic hash function on 1) an immutable unique device secret (UDS) embedded in the hub security controller 106 during manufacturing and 2) firmware measurements. The hub security controller 106 then uses the CDI to create a public/private key pair and uses the private key from that pair to create the CSR (which embeds the public key from the pair) and sends the CSR to the system security controller 105.

At time 211, the system security controller 105 signs the CSR it received from the hub security controller 106 using a CA private key, resulting in a signed certificate. This act of signing extends the system security controller 105's certificate trust chain to the signed certificate. The system security controller 105 then sends this signed certificate to the hub security controller 106. Because the hub security controller 106 possesses the private key for the public key embedded into the signed certificate, the hub security controller 106 can use this signed certificate for authenticating to an entity (e.g., secure application 104) that has a trust relationship with the system security controller 105.

At time 212, the hub security controller 106 “binds” itself to the signed certificate received from the system security controller 105. As long as the hub security controller 106 is bound to the signed certificate received from the system security controller 105, it uses that certificate for authentication. For example, if the hub security controller 106 already possesses a device identity certificate (e.g., provisioned at manufacturing or added later by an organization), it sets aside that device identity certificate in favor of the signed certificate received from the system security controller 105. For example, when the hub security controller 106 attempts to connect to the secure application 104 (communication channel 110), it uses the signed certificate received from the system security controller 105. In this situation, the secure application 104 can authenticate the certificate because it is aware of the CA at the system security controller 105. Because the secure application 104 can authenticate the hub security controller 106, the secure application 104 allows the hub security controller 106 to securely connect over TLS and provide inputs (e.g., from keyboard 108 and mouse 109).

Notably, if the peripheral hub 102 is removed from computer system 101 and connected to a different machine, and while remaining bound to the first system security controller 105, if the user attempts to connect to a secure application on the new machine, the secure application will not recognize the second system security controller and will reject the connection. However, the user can pair the peripheral hub 102 with the new machine using the process of communication diagram 200, which discards the signed certificate from the first system security controller 105 and replaces it with a signed certificate corresponding to the second system security controller of the new machine.

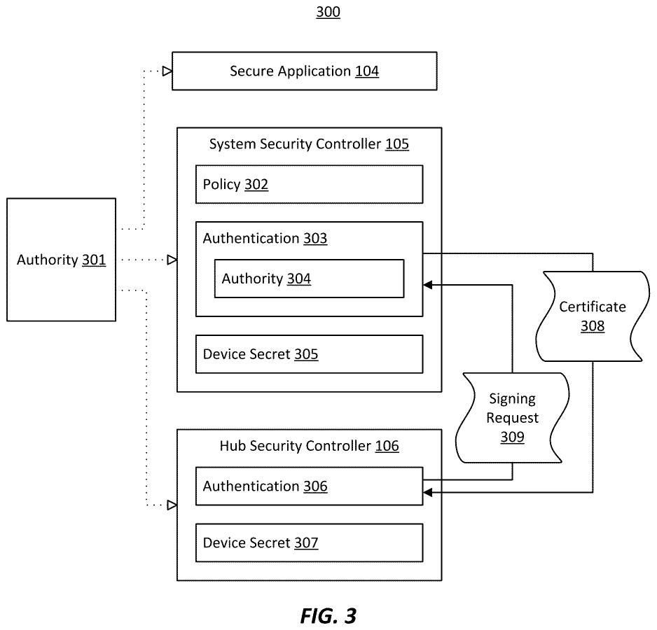

To describe this certificate binding in additional detail, FIG. 3 illustrates an example 300 of a system security controller issuing a security certificate to a hub security controller. In example 300, each of the secure application 104, the system security controller 105, and the hub security controller 106 are illustrated as trusting the same authority 301, such as a CA used to provision a device secret 305 and a device secret 307 (e.g., DICE UDSs) at system security controller 105 and hub security controller 106, respectively. Using device secret 307, an authentication component 306 at hub security controller 106 generates a signing request 309 and sends it to system security controller 105 (e.g., time 210, FIG. 2). For example, authentication component 306 derives a CDI using a cryptographic hash function on device secret 307 and firmware measurements, generates a public/private key pair from the CDI, and uses the public/private key pair to create the signing request 309. Upon receiving the signing request 309, an authentication component 303 at system security controller 105 signs the signing request 309 with a private key of a local authority 304, resulting in certificate 308 and sends certificate 308 to hub security controller 106 (e.g., time 211, FIG. 2). The hub security controller 106 can then use certificate 308 to authenticate with secure application 104.

Notably, the hub security controller 106 can utilize a policy component 302 to determine whether or not to sign the signing request 309, e.g., based on whether computer system 101 is connected to the corporate network, a geographic restriction, based on properties of the certificate of the CSR, or if there has been a manual approval (e.g., from a specific manager or information technology personnel). Additionally, or alternatively, hub security controller 106 can utilize policy component 302 to determine whether or not to initiate the pairing process before even getting to the point of certificate signing (e.g., when establishing a secure connection between system security controller 105 and hub security controller 106 at time 203 in FIG. 2).

Notably, in some embodiments, the hub security controller 106 includes logic to determine whether or not to permit devices to communicate with secure application 104 during the secure mode. In one example, hub security controller 106 filters devices based on their speed (e.g., low-speed devices such as keyboards and mice are permitted to communicate over communication channel 110, while high-speed devices such as webcams and storage devices are not). In another example using USB peripherals, hub security controller 106 may filter devices that use isochronous endpoints. In another example, hub security controller 106 controls the direction of data communications, e.g., by permitting data to flow from peripheral hub 102 to secure application 104, but not the other way.

In embodiments, it is ultimately up to the secure application 104 as to whether or not to communicate with peripheral hub 102, and the secure application 104 may refuse to communicate with peripheral hub 102 even if peripheral hub 102 is paired with system security controller 105. For example, the secure application 104 may consult a local or remote database of peripheral hubs and refuse to communicate with peripheral hub 102 if it is indicated to be stolen, lost, or associated with a different user or organization than expected.

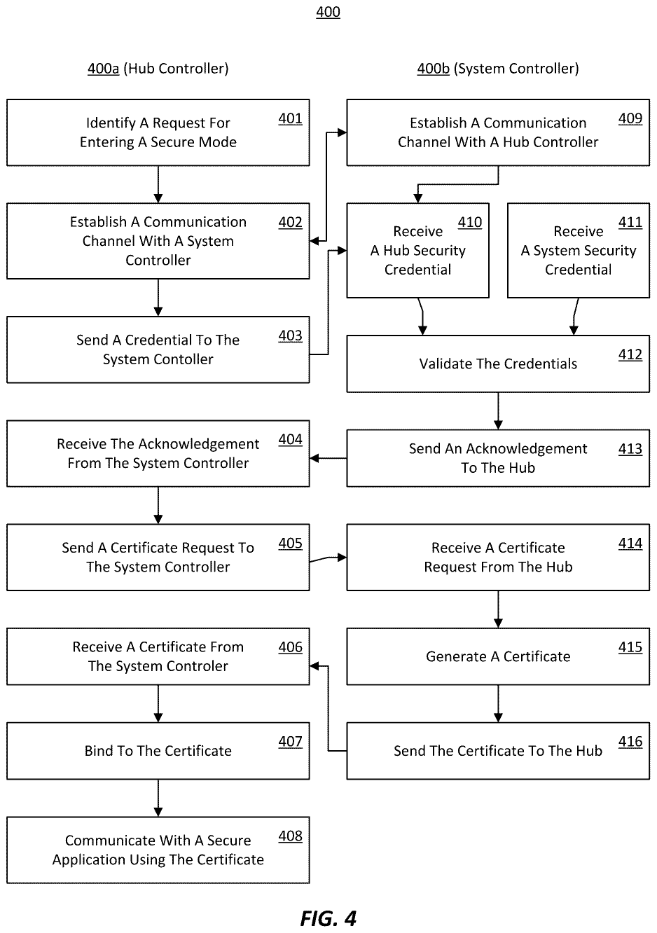

Embodiments are now described in connection with FIG. 4, which illustrates a flow chart of an example method 400 for pairing a hub security controller of a peripheral hub with a system security controller of a computer system. In embodiments, instructions for implementing method 400 are encoded as computer-executable instructions stored on a computer storage medium executable by a processor to cause a computer system (e.g., computer system 101, peripheral hub) to perform method 400.

The following discussion now refers to a number of methods and method acts. Although the method acts are discussed in specific orders or are illustrated in a flow chart as occurring in a particular order, no order is required unless expressly stated or required because an act is dependent on another act being completed before the act is performed.

In FIG. 4, method 400 includes acts 401-408, shown as method 400a, performed at a hub controller (e.g., hub security controller 106). Method 400 also includes acts 409-216, shown as method 400b, performed at a system controller (e.g., system security controller 105). Thus, in various examples, method 400 is a single method (method 400a) performed at hub security controller 106, a single method (method 400b) performed at system security controller 105, or a combined method (method 400) performed at a system that includes system security controller 105 and hub security controller 106.

Method 400a comprises act 401 of identifying a request for entering a secure mode. In embodiments, act 401 comprises identifying a first request to enter a secure peripheral mode. For example, identifying the request for entering secure mode could include identifying a user input, such as a key press or key combination at keyboard 108 or the pressing of a pairing button on peripheral hub 102. Thus, in some embodiments, identifying the first request to enter the secure peripheral mode comprises identifying a predefined key combination at the peripheral device. In some examples, identifying the request for entering secure mode includes identifying user inputs concurrently received at computer system 101 and peripheral hub 102.

Method 400a also comprises act 402 of establishing a communication channel with a system controller, while method 400b comprises act 409 of establishing a communication channel with a hub controller. In embodiments, act 402 comprises establishing a communication channel with a system security controller in a computer system that is communicatively coupled to the peripheral hub, establishing the communication channel including presenting a first cryptographic certificate to the system security controller. In embodiments, act 409 comprises establishing a communication channel with a hub security controller in a peripheral hub that is communicatively coupled to the computer system. For example, system security controller 105 and hub security controller 106 establish a secure TLS connection with each other based on device identity certificates provisioned on those devices (e.g., during manufacturing or by an organization). Thus, in some embodiments, the first cryptographic certificate is a device identity certificate installed on the hub security controller.

Method 400a also comprises act 403 of sending a credential to the system controller. In embodiments, act 403 comprises sending a credential via the communication channel to the system security controller, the credential being identified based on user interaction with a peripheral device coupled to the peripheral hub. For example, hub security controller 106 sends a PIN entered at keyboard 108 to system security controller 105.

Method 400b also comprises act 410 of receiving a hub security credential. In embodiments, act 410 comprises receiving a first credential via the communication channel from the hub security controller, the first credential originating from a first peripheral device coupled to the peripheral hub. For example, system security controller 105 receives the PIN sent by the hub security controller 106 in act 403.

Method 400b also comprises act 411 of receiving a system security credential. In embodiments, act 411 comprises receiving a second credential from a second peripheral device coupled to the system security controller. For example, system security controller 105 receives a PIN entered at keyboard 107.

Method 400b also comprises act 412 of validating the credentials. In embodiments, act 412 comprises determining that the first credential and the second credential are identical. For example, system security controller 105 determines if the PINs entered at keyboard 107 and keyboard 108 are identical.

Method 400b also comprises act 413 of sending an acknowledgment to the hub, while method 400a also comprises act 404 of receiving the acknowledgment from the system controller. In embodiments, act 413 comprises sending an acknowledgment via the communication channel of acceptance of the first credential to the hub security controller. In embodiments, act 404 comprises receiving the acknowledgment of acceptance of the credential by the system security controller via the communication channel. For example, if the PINs are determined by the system security controller 105 to be identical in act 412, the system security controller 105 sends an acknowledgment to the hub security controller 106. The hub security controller 106 then receives the acknowledgment sent by the system security controller 105 in act 413.

Method 400a also comprises act 405 of sending a certificate request to the system controller, while method 400b also comprises act 414 of receiving a certificate request from the hub. In embodiments, act 405 comprises sending a second request for a second cryptographic certificate via the communication channel to the system security controller. In embodiments, act 414 comprises receiving a request for a cryptographic certificate via the communication channel from the hub security controller. For example, authentication component 306 at hub security controller 106 generates and sends signing request 309 to authentication component 303 at system security controller 105. As discussed in connection with FIG. 3, in embodiments, authentication component 306 derives a CDI using a cryptographic hash function on device secret 307 and firmware measurements, generates a public/private key pair from the CDI, and uses the public/private key pair to create the signing request 309. Thus, in embodiments, the second request for the second cryptographic certificate includes a certificate signing request, the certificate signing request signed by a private key derived from an immutable device secret embedded on the hub security controller during manufacturing of the hub security controller.

Method 400b also comprises act 415 of generating a certificate. In embodiments, act 415 comprises generating the cryptographic certificate. For example, authentication component 303 at system security controller 105 generates certificate 308. As discussed in connection with FIG. 3, in embodiments, the authentication component 303 at system security controller 105 signs signing request 309 with a private key of a local authority 304, resulting in certificate 308. Thus, in embodiments, generating the cryptographic certificate includes signing the certificate signing request by a certificate authority at the system security controller.

Method 400b also comprises act 416 of sending the certificate to the hub, while method 400a also comprises act 406 of receiving a certificate from the system controller. In embodiments, act 416 comprises sending the cryptographic certificate via the communication channel to the hub security controller. In embodiments, act 406 comprises receiving the second cryptographic certificate from the system security controller via the communication channel.

Method 400a comprises act 407 of binding to the certificate. In embodiments, act 407 comprises binding the hub security controller to the system security controller, including replacing the first cryptographic certificate with the second cryptographic certificate for establishing a subsequent communications session with the system security controller. For example, hub security controller 106 sets aside its device identity certificate that was provisioned at manufacturing in favor of certificate 308, thereby binding itself to certificate 308.

Method 400a also comprises act 408 of communicating with a secure application using the certificate. In embodiments, act 408 comprises establishing a communication channel with an application executing in the computer system, the communication channel being secured based on the second cryptographic certificate. In embodiments, act 408 also comprises sending data over the second communication channel, the data received from the peripheral device. For example, hub security controller 106 establishes communication channel 110 with secure application 104 using certificate 308. Hub security controller 106 then communicates input data, e.g., from keyboard 108 and/or mouse 109, to secure application 104 over communication channel 110. In embodiments, the application trusts the data based on local authority 304 are system security controller 105 having signed certificate 308.

Notably, the hub security controller 106 can unbind itself from certificate 308 (e.g., after a subsequent pairing request) by reverting the use of its device identity certificate that was provisioned at manufacturing. Thus, in some embodiments, method 400a also comprises unbinding the hub security controller from the system security controller, including reverting to the first cryptographic certificate.

As mentioned, the hub security controller 106 may include logic to determine whether or not to permit devices to communicate with secure application 104 during the secure mode. For instance, the hub security controller 106 may filter devices based on their speed. Thus, in some embodiments of method 400a, the peripheral device is a first peripheral device and the hub security controller restricts communications by a second peripheral device coupled to the peripheral hub during the secure peripheral mode.

The disclosure herein therefore includes methods, systems, and computer program products for secure communication between a hub security controller of a peripheral hub and a system security controller of a computer system. The hub security controller identifies a request to enter a secure peripheral mode, establishes a communication channel with the system security controller by presenting a cryptographic certificate, and sends a credential based on user interaction with a peripheral device. Upon receiving acknowledgment, the hub security controller requests and receives a second cryptographic certificate, replacing the first for future sessions. The system security controller receives the credential, compares it with a second credential from another peripheral device, and sends acknowledgment if they match. It then generates and sends the second cryptographic certificate to the hub security controller. This process ensures secure communication and credential verification between the hub and system security controllers.

Alternatively or in addition to the other examples described herein, examples include any combination of the following:
Clause 1. A method implemented in a hub security controller of a peripheral hub comprising: identifying a first request to enter a secure peripheral mode; establishing a communication channel with a system security controller in a computer system that is communicatively coupled to the peripheral hub, wherein establishing the communication channel includes presenting a first cryptographic certificate to the system security controller; sending a credential via the communication channel to the system security controller, the credential being identified based on user interaction with a peripheral device coupled to the peripheral hub; receiving an acknowledgment of acceptance of the credential by the system security controller via the communication channel; sending a second request for a second cryptographic certificate via the communication channel to the system security controller; receiving the second cryptographic certificate from the system security controller via the communication channel; and binding the hub security controller to the system security controller, including replacing the first cryptographic certificate with the second cryptographic certificate for establishing a subsequent communications session with the system security controller.
Clause 2. The method of clause 1, wherein the first cryptographic certificate is a device identity certificate installed on the hub security controller.
Clause 3. The method of any of clauses 1-2, wherein the second request for the second cryptographic certificate includes a certificate signing request, the certificate signing request signed by a private key derived from an immutable device secret embedded on the hub security controller during manufacturing of the hub security controller.
Clause 4. The method of clause 3, wherein the second cryptographic certificate is derived from the certificate signing request and is signed by a certificate authority at the system security controller.
Clause 5. The method of any of clauses 1-4, wherein the method further comprises: unbinding the hub security controller from the system security controller, including reverting to the first cryptographic certificate.
Clause 6. The method of any of clauses 1-5, wherein: the communication channel is a first communication channel, and the method further comprises: establishing a second communication channel with an application executing in the computer system, wherein the second communication channel is secured based on the second cryptographic certificate; and sending data over the second communication channel, the data received from the peripheral device.
Clause 7. The method of clause 6, wherein the application trusts the data based on a certificate authority at the system security controller having signed the second cryptographic certificate.
Clause 8. The method of any of clauses 1-7, wherein identifying the first request to enter the secure peripheral mode comprises: identifying a predefined key combination at the peripheral device.
Clause 9. The method of any of clauses 1-8, wherein: the peripheral device is a first peripheral device; and the hub security controller restricts communications by a second peripheral device coupled to the peripheral hub during the secure peripheral mode.
Clause 10. A method, implemented in a system security controller of a computer system, comprising: establishing a communication channel with a hub security controller in a peripheral hub that is communicatively coupled to the computer system; receiving a first credential via the communication channel from the hub security controller, the first credential originating from a first peripheral device coupled to the peripheral hub; receiving a second credential from a second peripheral device coupled to the system security controller; determining that the first credential and the second credential are identical; sending an acknowledgment via the communication channel of acceptance of the first credential to the hub security controller; receiving a request for a cryptographic certificate via the communication channel from the hub security controller; generating the cryptographic certificate; and sending the cryptographic certificate via the communication channel to the hub security controller.
Clause 11. The method of clause 10, wherein establishing the communication channel includes: validating a device identity certificate received from the peripheral hub, wherein the device identity certificate is installed on the peripheral hub during manufacturing of the peripheral hub.
Clause 12. The method of any of clauses 10-11, wherein the request for the cryptographic certificate includes a certificate signing request, the certificate signing request signed by a private key derived from an immutable device secret embedded on the hub security controller during manufacturing of the hub security controller.
Clause 13. The method of clause 12, wherein generating the cryptographic certificate includes: signing the certificate signing request by a certificate authority at the system security controller.
Clause 14. A computer system, comprising: a hub security controller of a peripheral hub; and a system security controller of a computer system communicatively coupled to the peripheral hub, and wherein: the hub security controller includes first executable instructions that, when executed by a first processor at the hub security controller, cause the hub security controller to: identify a first request to enter a secure peripheral mode; establish a communication channel with the system security controller based on identifying the first request, wherein establishing the communication channel includes presenting a first cryptographic certificate to the system security controller; send a first credential to the system security controller via the communication channel, the first credential being identified based on user interaction with a peripheral device coupled to the peripheral hub; receive an acknowledgment of acceptance of the first credential by the system security controller via the communication channel; send a second request for a second cryptographic certificate via the communication channel to the system security controller; receive the second cryptographic certificate from the system security controller via the communication channel; and bind the hub security controller to the system security controller, including replacing the first cryptographic certificate with the second cryptographic certificate for establishing a subsequent communications session with the system security controller, and the system security controller includes second executable instructions that, when executed by a second processor at the system security controller, cause the system security controller to: receive the first credential via the communication channel; receive a second credential from a second peripheral device coupled to the system security controller; determine whether the first credential and the second credential are identical; send the acknowledgment via the communication channel when the first credential and the second credential are identical; receive the second request for the second cryptographic certificate via the communication channel from the hub security controller; generate the second cryptographic certificate; and send the second cryptographic certificate via the communication channel to the hub security controller.
Clause 15. The computer system of clause 14, wherein the first cryptographic certificate is a device identity certificate installed on the hub security controller.
Clause 16. The computer system of any of clauses 14-15, wherein the second request for the second cryptographic certificate includes a certificate signing request, the certificate signing request signed by a private key derived from an immutable device secret embedded on the hub security controller during manufacturing of the hub security controller.
Clause 17. The computer system of clause 16, wherein the second cryptographic certificate is derived from the certificate signing request and is signed by a certificate authority at the system security controller.
Clause 18. The computer system of any of clauses 14-17, wherein: the communication channel is a first communication channel, and the first executable instructions are also executable by the hub security controller to at least: establish a second communication channel with an application executing in the computer system, wherein the second communication channel is secured based on the second cryptographic certificate; and send data over the second communication channel, the data received from the peripheral device.
Clause 19. The computer system of clause 18, wherein the application trusts the data based on a certificate authority at the system security controller having signed the second cryptographic certificate.
Clause 20. The computer system of any of clauses 14-19, wherein: the peripheral device is a first peripheral device; and the hub security controller restricts communications by a second peripheral device coupled to the peripheral hub during the secure peripheral mode.

Embodiments of the disclosure comprise or utilize a special-purpose or general-purpose computer system (e.g., computer system 101, peripheral hub 102) that includes computer hardware, such as, for example, a processor system and system memory, as discussed in greater detail below. Embodiments within the scope of the present disclosure also include physical and other computer-readable media for carrying or storing computer-executable instructions and/or data structures. Such computer-readable media can be any available media accessible by a general-purpose or special-purpose computer system. Computer-readable media that store computer-executable instructions and/or data structures are computer storage media. Computer-readable media that carry computer-executable instructions and/or data structures are transmission media. Thus, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as random access memory (RAM), read-only memory (ROM), electrically erasable programmable ROM (EEPROM), solid state drives (SSDs), flash memory, phase-change memory (PCM), optical disk storage, magnetic disk storage or other magnetic storage devices, or any other hardware storage device(s) which store program code in the form of computer-executable instructions or data structures, which can be accessed and executed by a general-purpose or special-purpose computer system to implement the disclosed functionality.

Transmission media include a network and/or data links that carry program code in the form of computer-executable instructions or data structures that are accessible by a general-purpose or special-purpose computer system. A “network” is defined as a data link that enables the transport of electronic data between computer systems and other electronic devices. When information is transferred or provided over a network or another communications connection (either hardwired, wireless, or a combination thereof) to a computer system, the computer system may view the connection as transmission media. The scope of computer-readable media includes combinations thereof.

Upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module and eventually transferred to computer system RAM and/or less volatile computer storage media at a computer system. Thus, computer storage media can be included in computer system components that also utilize transmission media.

Computer-executable instructions comprise, for example, instructions and data which when executed at a processor system, cause a general-purpose computer system, a special-purpose computer system, or a special-purpose processing device to perform a function or group of functions. In embodiments, computer-executable instructions comprise binaries, intermediate format instructions (e.g., assembly language), or source code. In embodiments, a processor system comprises one or more central processing units (CPUs), one or more graphics processing units (GPUs), one or more neural processing units (NPUs), and the like.

In some embodiments, the disclosed systems and methods are practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. In some embodiments, the disclosed systems and methods are practiced in distributed system environments where different computer systems, which are linked through a network (e.g., by hardwired data links, wireless data links, or by a combination of hardwired and wireless data links), both perform tasks. As such, in a distributed system environment, a computer system may include a plurality of constituent computer systems. Program modules may be located in local and remote memory storage devices in a distributed system environment.

In some embodiments, the disclosed systems and methods are practiced in a cloud computing environment. In some embodiments, cloud computing environments are distributed, although this is not required. When distributed, cloud computing environments may be distributed internally within an organization and/or have components possessed across multiple organizations. In this description and the following claims, “cloud computing” is a model for enabling on-demand network access to a shared pool of configurable computing resources (e.g., networks, servers, storage, applications, and services). A cloud computing model can be composed of various characteristics, such as on-demand self-service, broad network access, resource pooling, rapid elasticity, measured service, and so forth. A cloud computing model may also come in the form of various service models such as Software as a Service (SaaS), Platform as a Service (PaaS), Infrastructure as a Service (IaaS), etc. The cloud computing model may also be deployed using different deployment models such as private cloud, community cloud, public cloud, hybrid cloud, etc.

Some embodiments, such as a cloud computing environment, comprise a system with one or more hosts capable of running one or more virtual machines (VMs). During operation, VMs emulate an operational computing system, supporting an operating system (OS) and perhaps one or more other applications. In some embodiments, each host includes a hypervisor that emulates virtual resources for the VMs using physical resources that are abstracted from the view of the VMs. The hypervisor also provides proper isolation between the VMs. Thus, from the perspective of any given VM, the hypervisor provides the illusion that the VM is interfacing with a physical resource, even though the VM only interfaces with the appearance (e.g., a virtual resource) of a physical resource. Examples of physical resources include processing capacity, memory, disk space, network bandwidth, media drives, and so forth.

Although the subject matter has been described in language specific to structural features and/or methodological acts, it is to be understood that the subject matter defined in the appended claims is not necessarily limited to the described features or acts described supra or the order of the acts described supra. Rather, the described features and acts are disclosed as example forms of implementing the claims.

The present disclosure may be embodied in other specific forms without departing from its essential characteristics. The described embodiments are only illustrative and not restrictive. All changes that come within the meaning and range of equivalency of the claims are to be embraced within their scope.

When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset. Unless otherwise specified, the term “subset” excludes the entirety of its superset (i.e., the superset contains at least one item not included in the subset). Unless otherwise specified, a “superset” can include at least one additional element, and a “subset” can exclude at least one element.

What is claimed:

1. A method implemented in a hub security controller of a peripheral hub comprising:
identifying a first request to enter a secure peripheral mode;
establishing a communication channel with a system security controller in a computer system that is communicatively coupled to the peripheral hub, wherein establishing the communication channel includes presenting a first cryptographic certificate to the system security controller;
sending a credential via the communication channel to the system security controller, the credential being identified based on user interaction with a peripheral device coupled to the peripheral hub;
receiving an acknowledgment of acceptance of the credential by the system security controller via the communication channel;
sending a second request for a second cryptographic certificate via the communication channel to the system security controller;
receiving the second cryptographic certificate from the system security controller via the communication channel; and
binding the hub security controller to the system security controller, including replacing the first cryptographic certificate with the second cryptographic certificate for establishing a subsequent communications session with the system security controller.

2. The method of claim 1, wherein the first cryptographic certificate is a device identity certificate installed on the hub security controller.

3. The method of claim 1, wherein the second request for the second cryptographic certificate includes a certificate signing request, the certificate signing request signed by a private key derived from an immutable device secret embedded on the hub security controller during manufacturing of the hub security controller.

4. The method of claim 3, wherein the second cryptographic certificate is derived from the certificate signing request and is signed by a certificate authority at the system security controller.

5. The method of claim 1, wherein the method further comprises:
unbinding the hub security controller from the system security controller, including reverting to the first cryptographic certificate.

6. The method of claim 1, wherein:
the communication channel is a first communication channel, and the method further comprises:
establishing a second communication channel with an application executing in the computer system, wherein the second communication channel is secured based on the second cryptographic certificate; and
sending data over the second communication channel, the data received from the peripheral device.

7. The method of claim 6, wherein the application trusts the data based on a certificate authority at the system security controller having signed the second cryptographic certificate.

8. The method of claim 1, wherein identifying the first request to enter the secure peripheral mode comprises:
identifying a predefined key combination at the peripheral device.

9. The method of claim 1, wherein:
the peripheral device is a first peripheral device; and
the hub security controller restricts communications by a second peripheral device coupled to the peripheral hub during the secure peripheral mode.

10. A method, implemented in a system security controller of a computer system, comprising:
establishing a communication channel with a hub security controller in a peripheral hub that is communicatively coupled to the computer system;
receiving a first credential via the communication channel from the hub security controller, the first credential originating from a first peripheral device coupled to the peripheral hub;
receiving a second credential from a second peripheral device coupled to the system security controller;
determining that the first credential and the second credential are identical;
sending an acknowledgment via the communication channel of acceptance of the first credential to the hub security controller;
receiving a request for a cryptographic certificate via the communication channel from the hub security controller;
generating the cryptographic certificate; and
sending the cryptographic certificate via the communication channel to the hub security controller.

11. The method of claim 10, wherein establishing the communication channel includes:
validating a device identity certificate received from the peripheral hub, wherein the device identity certificate is installed on the peripheral hub.

12. The method of claim 10, wherein the request for the cryptographic certificate includes a certificate signing request, the certificate signing request signed by a private key derived from an immutable device secret embedded on the hub security controller during manufacturing of the hub security controller.

13. The method of claim 12, wherein generating the cryptographic certificate includes:
signing the certificate signing request by a certificate authority at the system security controller.

14. A computer system, comprising:
a hub security controller of a peripheral hub; and
a system security controller of a computer system communicatively coupled to the peripheral hub, and wherein:
the hub security controller includes first executable instructions that, when executed by a first processor at the hub security controller, cause the hub security controller to:
identify a first request to enter a secure peripheral mode;
establish a communication channel with the system security controller based on identifying the first request, wherein establishing the communication channel includes presenting a first cryptographic certificate to the system security controller;
send a first credential to the system security controller via the communication channel, the first credential being identified based on user interaction with a peripheral device coupled to the peripheral hub;
receive an acknowledgment of acceptance of the first credential by the system security controller via the communication channel;
send a second request for a second cryptographic certificate via the communication channel to the system security controller;
receive the second cryptographic certificate from the system security controller via the communication channel; and
bind the hub security controller to the system security controller, including replacing the first cryptographic certificate with the second cryptographic certificate for establishing a subsequent communications session with the system security controller, and
the system security controller includes second executable instructions that, when executed by a second processor at the system security controller, cause the system security controller to:
receive the first credential via the communication channel;
receive a second credential from a second peripheral device coupled to the system security controller;
determine whether the first credential and the second credential are identical;
send the acknowledgment via the communication channel when the first credential and the second credential are identical;
receive the second request for the second cryptographic certificate via the communication channel from the hub security controller;
generate the second cryptographic certificate; and
send the second cryptographic certificate via the communication channel to the hub security controller.

15. The computer system of claim 14, wherein the first cryptographic certificate is a device identity certificate installed on the hub security controller.

16. The computer system of claim 14, wherein the second request for the second cryptographic certificate includes a certificate signing request, the certificate signing request signed by a private key derived from an immutable device secret embedded on the hub security controller during manufacturing of the hub security controller.

17. The computer system of claim 16, wherein the second cryptographic certificate is derived from the certificate signing request and is signed by a certificate authority at the system security controller.

18. The computer system of claim 14, wherein:
the communication channel is a first communication channel, and
the first executable instructions are also executable by the hub security controller to at least:
establish a second communication channel with an application executing in the computer system, wherein the second communication channel is secured based on the second cryptographic certificate; and
send (408) data over the second communication channel, the data received from the peripheral device.

19. The computer system of claim 18, wherein the application trusts the data based on a certificate authority at the system security controller having signed the second cryptographic certificate.

20. The computer system of claim 14, wherein:
the peripheral device is a first peripheral device; and
the hub security controller restricts communications by a second peripheral device coupled to the peripheral hub during the secure peripheral mode.
